(19) United States
(12) Patent Application Publication
(10) Pub. No.: US 2006/0228943 A1
(43) Pub. Date: Oct. 12, 2006

(54) Retractable undercut core pull

(75) Inventor: Michael L. Grinnall, Clinton, IA (US)

Correspondence Address: ST. ONGE STEWARD JOHNSTON & REENS, LLC, 986 BEDFORD STREET, STAMFORD, CT, 06905-5619, US

(73) Assignee: Custom-Pak, Inc.

(21) Appl. No.: 11/402,231

(22) Filed: Apr. 11, 2006

Related U.S. Application Data
(60) Provisional application No. 60/670,389, filed on Apr. 12, 2005.

(51) Int. Cl. H01R 13/40

(52) U.S. Cl. 439/590

(57) ABSTRACT

A core side of a mold includes a mold surface against which the article bears during molding, a core pull and an ejector pin. The core pull includes a protuberance moveable between an extended position in which the protuberance protrudes beyond the mold surface, and a retracted position in which the protuberance does not substantially protrude beyond the mold surface. The ejector pin includes an end moveable between an extended position in which the end protrudes beyond the mold surface, and a retracted position in which the end does not substantially protrude beyond the mold surface. The protuberance is in the extended position and the ejector pin end is in the retracted position during a part retaining portion of a mold cycle, while the protuberance is in the retracted position and the ejector pin end is in the extended position during a part ejecting portion of the mold cycle.

### RELATED APPLICATIONS

This patent application claims the benefit of, under Title 35, United States Code, Section 119(e), U.S. Provisional Patent Application No. 60/670,389, filed Apr. 12, 2005.

### FIELD OF THE INVENTION

The present invention relates generally to double wall blow molded plastic articles, and more particularly, to an apparatus and method used to blow mold such articles.

### BACKGROUND OF THE INVENTION

Double wall blow molded articles have been in widespread use for decades. Such articles provide, at modest cost, a desirable combination of physical properties, such as rigidity, protection of contents (in the case of carrying cases and the like), scuff resistance and absorption of impact. Because of this favorable cost/benefit combination, such articles have steadily increased their share of the plastic molded article market, of which they presently account for a significant portion.

As is well known, double wall articles are produced by inflating and then cooling, by fluid means, a large diameter tube or “parison” of molten plastic material between mating mold halves. In general, one of the mating mold halves forms the “exterior” shape of the cavity and the other forms the “interior” of the article, which “interior” forming mold half is designated the mold “core”. With certain articles, it is relatively easy to distinguish the “exterior” and “interior” sides of the article. For example, in the case of carrying cases, the outer wall is readily distinguished from the inner compartmentation of either the lid or base portion, which inner compartmentation is generally formed by the mold core half of the mold. However, in connection with other articles, it may not be as easy to distinguish the “exterior” and “interior” sides of the article. For example, in the case of a double wall blow molded seat member, it may not be readily apparent which side is formed by the mold “core.” However, as will be appreciated from the more detailed description below, there still typically exists one half of the mold which comprises the mold “core.”

A particular advantage of the double wall blow molding process described above is that these “exterior” and “interior” walls do not have to match, since the space between them is filled by air. It is usually desirable to design the article “exterior” as an unbroken attractive shape, whereas the “interior” is often formed in a compartmented configuration to hold a specific and irregular set of contents, such as, for example, a circular saw or an electric drill with accessories (in the case of carrying cases), or in a configuration which includes various attachment mechanisms, surfaces designed to mate with other objects, or some other types of specialized shape (in the case of other types of articles).

During the molding operation, it is important to achieve mechanical ejection of parts from the mold, in order to avoid the cost, the cycle irregularities, and the safety hazards inherent with having a machine operator reach into the mold area to remove parts. During the mold-closed forming and cooling cycle, the molten plastic tends to drape over a male mold core and then to shrink onto it as the plastic cools; this provides a degree of adherence of part to mold. In an ideal situation, the plastic on the cavity side of said mold will shrink away from the cavity walls, minimizing adherence to cavity mold surfaces. This differential adherence will hold the part on the core half of the mold as the mold opens at the end of the forming cycle. Then, at or near the end of the mold-opening portion of the cycle, ejector pins, oriented to move parallel to the mold open-close plane of the mold, are activated to push the molded “interior” portion of the article off the face of the mold core.

Unfortunately, double wall article blow molding rarely lends itself to ideal situations. Cavities tend to be at least partially covered with decorative, acid-etched grain or pebble texture, and the etching process forms minute (but myriad) undercuts in the texture surface adjacent to the main cavity body. This can, and does, form substantial and undesirable adherence between plastic and cavity on the “wrong” side of the mold. Furthermore, mold cavities may have intentional and necessary undercuts, such as for integrally molded feet or relief areas around latches or other similar features. In many, if not most, commercial situations, these undercuts, if not somehow nullified, would hold the molded parts on the cavity side of the mold, completely negating the potential effect of the ejector pins. From a practical design standpoint of both part and mold, it is usually impractical to put ejectors on the cavity side of the mold, either in or adjacent to the cavity itself.

Traditionally, ball undercuts have been made on the side walls of mold cores in order to hold parts on the cores as the mold opens. Then, at the end of the opening cycle, ejector pins on the mold core faces are activated to push the parts off the undercuts. While this system may be satisfactory for small or shallow articles, it becomes increasingly unwieldy as article size and depth increase. The bigger or deeper the article, the more undesirable adherence occurs on the cavity side. The more adherence on this “wrong” side, the bigger and deeper the undercuts must be on the core side to pull the part out of the cavity. And the bigger these undercuts, the more likely that the ejector pins, when activated, will deform the part, or that the ejector pins will not supply enough force to move the part off the undercuts.

The mold making department in may facilities installs what it considers to be the maximum practical undercuts. It is then the job of the process engineers, while sampling the mold, to blend out the interferences to eliminate sharp edges and reduce core interference to its usable minimum. This is delicate and aggravating work, particularly since it involves interrupting a sampling cycle and risking marring of mold surfaces. Worse yet, there is no permanent “right” setting for this work, because the degree of inherent undercuts on both core and cavity sides of the mold change as the mold wears in. For example, a part that sticks hard in the cavity on the first shot using the mold may stick significantly less on the hundredth shot, and by the thousandth shot, it may stick vigorously on the core side.

What is desired, therefore, is an apparatus and method for creating double wall blow molded plastic articles which facilitates the articles being retained on the core side of the mold when the mold is opened during creation of the articles, which allows the ejector pins, when activated, to move the articles off the core side of the mold without deforming the articles, which does not require that interferences be blended out to eliminate sharp edges and reduce core interference to its usable minimum while sampling the mold, and which is not materially affected as the mold is broken in during use.

### SUMMARY OF THE INVENTION

Accordingly, it is an object of the present invention to provide an apparatus and method for creating double wall blow molded plastic articles which facilitates the articles being retained on the core side of the mold when the mold is opened during creation of the articles.

Another object of the present invention is to provide an apparatus and method for creating double wall blow molded plastic articles having the above characteristics and which allows the ejector pins, when activated, to move the articles off the core side of the mold without deforming the articles.

A further object of the present invention is to provide an apparatus and method for creating double wall blow molded plastic articles having the above characteristics and which does not require that interferences be blended out to eliminate sharp edges and reduce core interference to its usable minimum while sampling the mold.

Still another object of the present invention is to provide an apparatus and method for creating double wall blow molded plastic articles having the above characteristics and which is not materially affected as the mold is broken in during use.

These and other objects of the present invention are achieved, in accordance with one embodiment of the present invention, by provision of a mold for creating an article, the mold having a cavity side and a core side. The core side of the mold includes a mold surface against which the article bears during molding, at least one core pull disposed within the core side of the mold, and at least one ejector pin disposed within the core side of the mold. The at least one core pull includes a protuberance moveable between an extended position in which the protuberance protrudes beyond the mold surface, and a retracted position in which the protuberance does not substantially protrude beyond the mold surface. The at least one ejector pin includes an end moveable between an extended position in which the end protrudes beyond the mold surface, and a retracted position in which the end does not substantially protrude beyond the mold surface. The protuberance of the at least one core pull is in the extended position thereof and the end of the at least one ejector pin is in the retracted position thereof during a part retaining portion of a mold cycle, while the protuberance of the at least one core pull is in the retracted position thereof and the end of the at least one ejector pin is in the extended position thereof during a part ejecting portion of the mold cycle.

In some embodiments, the at least one core pull is disposed such that the protuberance thereof is moveable generally perpendicular to a mold open-close plane of the mold. In certain of these embodiments, the at least one ejector pin is disposed such that the end thereof is moveable generally parallel to the mold open-close plane of the mold. In some embodiments, the at least one core pull comprises a piston, and the protuberance comprises a portion of the piston. In certain of these embodiments, the piston is moveable at least in part in response to fluid pressure. In certain of these embodiments, the fluid pressure comprises pneumatic pressure.

In certain embodiments, the at least one core pull comprises a spring biasing the piston such that the protuberance is in the retracted position thereof, and the piston is moveable against the bias of the spring such that the protuberance is in the extended position thereof in response to fluid pressure. In certain embodiments, the at least one core pull comprises a spring biasing the piston such that the protuberance is in the extended position thereof, and the piston is moveable against the bias of the spring such that the protuberance is in the retracted position thereof in response to fluid pressure. In certain embodiments, the piston is moveable from a position such that the protuberance is in the retracted position thereof to a position such that the protuberance is in the extended position thereof by application of positive fluid pressure, and is moveable from the position such that the protuberance is in the extended position thereof to the position such that the protuberance is in the retracted position thereof by application of negative fluid pressure.

In accordance with another embodiment of the present invention, a mold for creating a double wall blow molded article has a cavity side and a core side. The core side of the mold includes a mold surface against which the article bears during molding, at least one core pull disposed within the core side of the mold, and at least one ejector pin disposed within the core side of the mold. The at least one core pull includes a piston having a protuberance, the piston being moveable, at least partially in response to fluid pressure, between an extended position in which the protuberance protrudes beyond the mold surface, and a retracted position in which the protuberance does not substantially protrude beyond the mold surface, the piston being moveable generally perpendicular to a mold open-close plane of the mold. The at least one ejector pin includes an end moveable between an extended position in which the end protrudes beyond the mold surface, and a retracted position in which the end does not substantially protrude beyond the mold surface, the end being moveable generally parallel to the mold open-close plane of the mold. The protuberance of the at least one core pull is in the extended position thereof and the end of the at least one ejector pin is in the retracted position thereof during a part retaining portion of a mold cycle, while the protuberance of the at least one core pull is in the retracted position thereof and the end of the at least one ejector pin is in the extended position thereof during a part ejecting portion of the mold cycle.

In some embodiments, the fluid pressure comprises pneumatic pressure. In some embodiments, the at least one core pull comprises a spring biasing the piston such that the protuberance is in the retracted position thereof, and the piston is moveable against the bias of the spring such that the protuberance is in the extended position thereof in response to fluid pressure. In some embodiments, the at least one core pull comprises a spring biasing the piston such that the protuberance is in the extended position thereof, and the piston is moveable against the bias of the spring such that the protuberance is in the retracted position thereof in response to fluid pressure. In some embodiments, the piston is moveable from a position such that the protuberance is in the retracted position thereof to a position such that the protuberance is in the extended position thereof by application of positive fluid pressure, and is moveable from the position such that the protuberance is in the extended position thereof to the position such that the protuberance is in the retracted position thereof by application of negative fluid pressure.

In accordance with a further embodiment of the present invention, a mold for creating a double wall blow molded article has a cavity side and a core side. The core side of the mold includes a mold surface against which the article bears during molding, and at least one core pull disposed within the core side of the mold. The at least one core pull includes a piston having a protuberance, the piston being moveable, at least partially in response to fluid pressure, between an extended position in which the protuberance protrudes beyond the mold surface, and a retracted position in which the protuberance does not substantially protrude beyond the mold surface, the piston being moveable generally perpendicular to a mold open-close plane of the mold. The protuberance of the at least one core pull is in the extended position thereof during a part retaining portion of a mold cycle, and the protuberance of the at least one core pull is in the retracted position thereof during a part ejecting portion of the mold cycle.

In some embodiments, the fluid pressure comprises pneumatic pressure. In some embodiments, the at least one core pull comprises a spring biasing the piston such that the protuberance is in the retracted position thereof, and the piston is moveable against the bias of the spring such that the protuberance is in the extended position thereof in response to fluid pressure. In some embodiments, the at least one core pull comprises a spring biasing the piston such that the protuberance is in the extended position thereof, and the piston is moveable against the bias of the spring such that the protuberance is in the retracted position thereof in response to fluid pressure. In some embodiments, the piston is moveable from a position such that the protuberance is in the retracted position thereof to a position such that the protuberance is in the extended position thereof by application of positive fluid pressure, and is moveable from the position such that the protuberance is in the extended position thereof to the position such that the protuberance is in the retracted position thereof by application of negative fluid pressure.

In accordance with a further embodiment of the present invention, a method of creating an article includes the steps of: (i) providing a mold having a cavity side and a core side, the core side having a mold surface against which the article bears during molding, (ii) causing a protuberance of at least one core pull to protrude beyond the mold surface, (iii) causing an end of at least one ejector pin to be retracted such that it does not substantially protrude beyond the mold surface, (iv) molding the article within the mold, (v) opening the mold, (vi) retracting the protuberance of the at least one core pull such that it does not substantially protrude beyond the mold surface, and (vii) ejecting the article from the core side of the mold by causing the end of the at least one ejector pin to protrude beyond the mold surface.

In some embodiments, the at least one core pull is disposed such that the protuberance thereof is moveable generally perpendicular to a mold open-close plane of the mold. In certain of these embodiments, the at least one ejector pin is disposed such that the end thereof is moveable generally parallel to the mold open-close plane of the mold. In some embodiments, the at least one core pull comprises a piston, and the protuberance comprises a portion of the piston. In certain of these embodiments, the piston is moveable at least in part in response to fluid pressure. In certain of these embodiments, the fluid pressure comprises pneumatic pressure.

In certain embodiments, the at least one core pull comprises a spring biasing the piston such that the protuberance does not substantially protrude beyond the mold surface, and the piston is moveable against the bias of the spring, in response to fluid pressure, such that the protuberance protrudes beyond the mold surface. In certain embodiments, the at least one core pull comprises a spring biasing the piston such that the protuberance protrudes beyond the mold surface, and the piston is moveable against the bias of the spring, in response to fluid pressure, such that the protuberance does not substantially protrude beyond the mold surface. In certain embodiments, the piston is moveable from a position such that the protuberance does not substantially protrude beyond the mold surface to a position such that the protuberance protrudes beyond the mold surface by application of positive fluid pressure, and is moveable from the position such that the protuberance protrudes beyond the mold surface to the position such that the protuberance does not substantially protrude beyond the mold surface by application of negative fluid pressure.

The invention and its particular features and advantages will become more apparent from the following detailed description considered with reference to the accompanying drawings.

### BRIEF DESCRIPTION OF THE DRAWINGS

FIG. 1 is a partially cross-sectional view of a portion of a mold core in accordance with an embodiment of the present invention in a part retaining position, in which a moveable undercut core pull is in an extended position and a knock out pin is in a retracted position;

FIG. 2 is a partially cross-sectional view of the portion of the mold core of FIG. 1 in a part ejecting position, in which the moveable undercut core pull is in a retracted position and the knock out pin is in an extended position; and

FIGS. 3A-3C are partially cross-sectional views of moveable undercut core pulls in accordance with the present invention useable in conjunction with the mold core shown in FIGS. 1 and 2.

### DETAILED DESCRIPTION OF AN EMBODIMENT OF THE INVENTION

The present invention overcomes the deficiencies associated with the prior art described above by making the interference of the core pulls easily variable during the course of the cycle from being fully extended, thereby fully engaging the article being molded, to being fully retracted, thereby not engaging the article being molded at all.

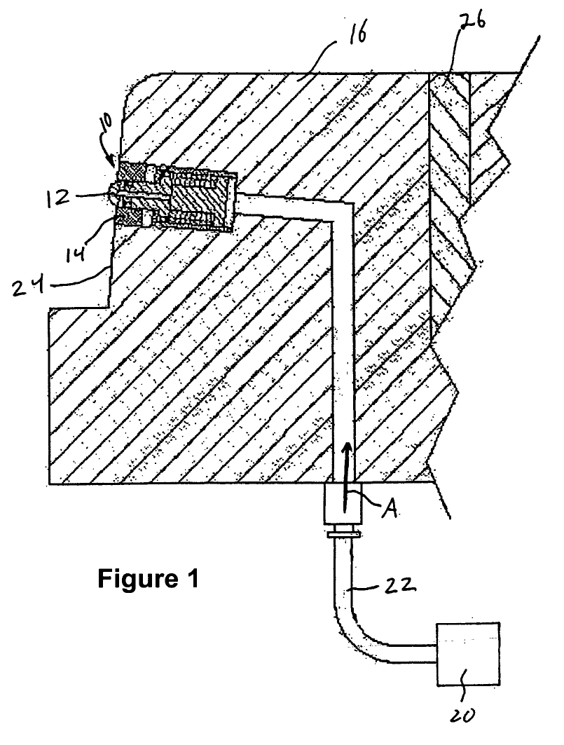

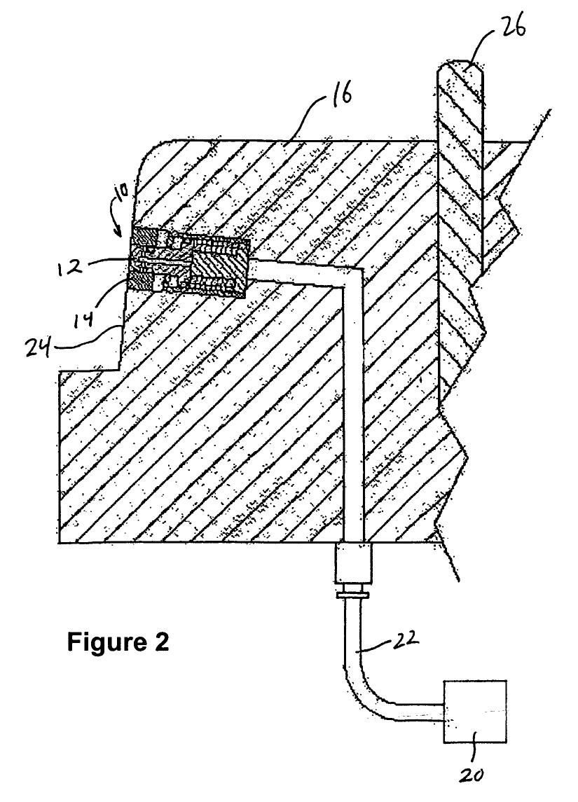

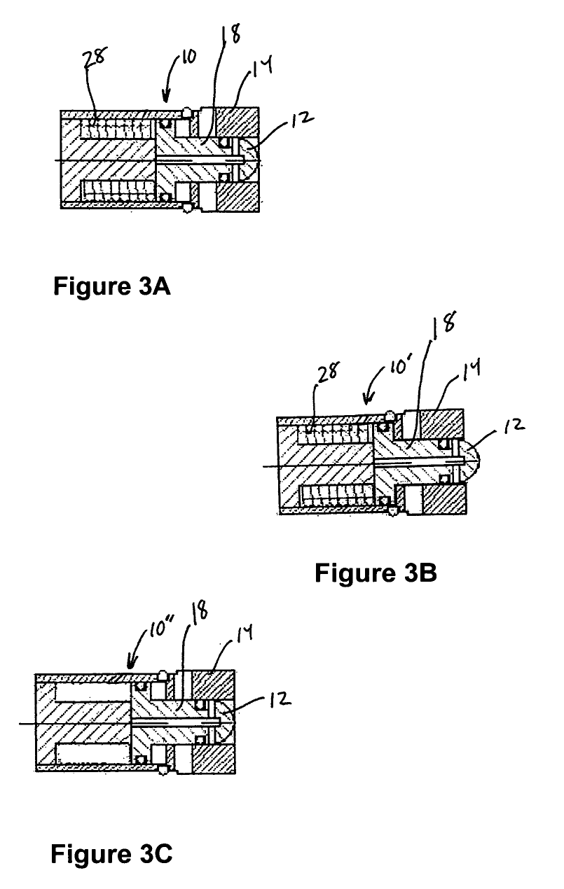

As best seen in FIGS. 1 and 2, the core pulls 10 include a moveable protuberance 12 mounted into small cylinders 14 press fitted into the side walls of the core side of the mold 16. Protuberance 12 may form an end part of a piston 18 (see FIGS. 3A-3C), which is connected to a source 20 of fluid pressure via a conduit 22 or the like.

Before or during the mold-close portion of the manufacturing cycle, the pressure within the conduit 22 is adjusted or maintained such that protuberance 12 is in an extended position in which an end thereof protrudes beyond the mold surface 24, as is shown in FIG. 1. The same or other fluid or spring means are used to also retract one or more ejector pins 26, also as is shown in FIG. 1. It should be understood by those skilled in the art that ejector pins 26 are optional components, in that some other type of part ejection means, such as a robotic part picker, may be employed in addition to or instead of ejector pins 26. It should also be understood that, as discussed above, it is sometimes difficult to determine which side of the mold is the “core” side and which is the “cavity” side. As such, the term “core” side is herein used to mean the side in which the core pulls 10 and the optional ejector pins 26 are provided, whether or not by some other criteria the side with the core pulls 10 and optional ejector pins 26 might be viewed as the “cavity” side.

At the end of the forming cycle, as the mold starts to open, protuberance 12 remains in its extended position, gripping the molded core and pulling it free of the cavity. At or near the end of the mold opening portion of the cycle, fluid pressure within the conduit 22 is adjusted such that protuberance 12 is moved to a retracted position in which the protuberance 12 does not substantially protrude beyond the mold surface 24. Immediately thereafter, the ejector pin(s) 26 are activated to push the molded core off the matching mold core 16, all as shown in FIG. 2. It is also possible to vary the degree to which protuberance 12 protrudes beyond the mold surface 24 by varying the amount of fluid pressure within the conduit 22. It is preferred, but not required, that the fluid pressure be pneumatic pressure.

In order for mold core 16 to function optimally, it is preferred that the core pull 10 be disposed such that the protuberance 12 thereof is moveable generally perpendicular to a mold open-close plane of the mold, as is shown in FIG. 1. Similarly, it is preferred that the ejector pin 26 is disposed such that the end thereof is moveable generally parallel to the mold open-close plane of the mold, also as is shown in FIG. 1.

Referring now to FIGS. 3A-3C, several alternative configurations for core pull 10, 10′, 10″ are shown. In the configurations shown in FIGS. 3A and 3B, core pull 10, 10′ includes a spring 28, 28′ biasing the piston 18, in the absence of pressurized fluid within the conduit 22, such that the protuberance 12 is in the retracted position thereof (shown in FIGS. 1, 2 and 3A), or such that the protuberance 12 is in the extended position thereof (shown in FIG. 3B).

In the former case (i.e., the one shown in FIGS. 1, 2 and 3A), the protuberance 12 is moveable against the bias of the spring 28 such that the protuberance 12 is in the extended position thereof in response to positive fluid pressure within the conduit 22 (indicated by arrow A in FIG. 1). When the positive fluid pressure is removed, the protuberance 12 moves to its retracted position (shown in FIG. 2). In the latter case (i.e., the one shown in FIG. 3B), the protuberance 12 is moveable against the bias of the spring 28′ such that the protuberance 12 is in the retracted position thereof in response to negative fluid pressure (e.g., vacuum) within the conduit 22. When the negative fluid pressure is removed, the protuberance 12 moves to its extended position.

Referring now to FIG. 3C, it is also possible that core pull 10 includes no spring, such that the protuberance is not biased in either direction. In such a case, the piston 18 is moveable from a position such that the protuberance 12 is in the retracted position thereof to a position such that the protuberance 12 is in the extended position thereof by application of positive fluid pressure within the conduit 22, and is moveable from the position such that the protuberance 12 is in the extended position thereof to the position such that the protuberance 12 is in the retracted position thereof by application of negative fluid pressure (e.g., vacuum) within the conduit 22.

It will be seen that the present invention completely overcomes the adherence problems encountered with fixed core pulls. The movable protuberance 12 (extended) allows the pulling force necessary to drag the part out of the cavity to be maximized. Then, when the part has broken free, this pulling force is reduced to zero by retracting the protuberance 12.

The specific design of this apparatus is in no way limited to the embodiment illustrated, and the particular arrangement of parts and features herein described are not intended to exhaust all possible arrangements of parts and features. For example, the end cross section of the protuberance 12 can be triangular or any other convenient shape, not just semi-circular, and the outline of the protuberance can be oval instead of round, for example. And core pull interference can be stopped at different times on different mold surfaces during mold opening. For example, in carrying cases where undercut integral feet are included, it is often desirable to twist the part off the core, removing the feet side last. This may be accomplished by deactivating the core pulls first on the feet side and then pushing out the ejector pins first on the opposite (handle) side after adjacent core pulls have also been released. Indeed, many other variations and modifications will be ascertainable to those skilled in the art.

From the forgoing description and illustrations, it will be seen that the present invention accomplishes its intent, offering significant benefits over the prior art. Molding cycles are made more dependable; mold design is less subject to in-line modification; and part appearance and production economies increase.

The present invention, therefore, provides an apparatus and method for creating double wall blow molded plastic articles which facilitates the articles being retained on the core side of the mold when the mold is opened during creation of the articles, which allows the ejector pins, when activated, to move the articles off the core side of the mold without deforming the articles, which does not require that interferences be blended out to eliminate sharp edges and reduce core interference to its usable minimum while sampling the mold, and which is not materially affected as the mold is broken in during use.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A mold for creating an article, the mold having a cavity side and a core side, the core side of said mold comprising:
a mold surface against which the article bears during molding;
at least one core pull disposed within the core side of said mold, said at least one core pull comprising a protuberance moveable between an extended position in which the protuberance protrudes beyond the mold surface, and a retracted position in which the protuberance does not substantially protrude beyond the mold surface;
at least one ejector pin disposed within the core side of said mold, said at least one ejector pin comprising an end moveable between an extended position in which the end protrudes beyond the mold surface, and a retracted position in which the end does not substantially protrude beyond the mold surface;
wherein the protuberance of said at least one core pull is in the extended position thereof and the end of said at least one ejector pin is in the retracted position thereof during a part retaining portion of a mold cycle; and
wherein the protuberance of said at least one core pull is in the retracted position thereof and the end of said at least one ejector pin is in the extended position thereof during a part ejecting portion of the mold cycle.

2. The mold of claim 1 wherein said at least one core pull is disposed such that the protuberance thereof is moveable generally perpendicular to a mold open-close plane of said mold.

3. The mold of claim 2 wherein said at least one ejector pin is disposed such that the end thereof is moveable generally parallel to the mold open-close plane of said mold.

4. The mold of claim 1 wherein said at least one core pull comprises a piston, and wherein the protuberance comprises a portion of the piston.

5. The mold of claim 4 wherein the piston is moveable at least in part in response to fluid pressure.

6. The mold of claim 5 wherein the fluid pressure comprises pneumatic pressure.

7. The mold of claim 5 wherein said at least one core pull comprises a spring biasing the piston such that the protuberance is in the retracted position thereof, and wherein the piston is moveable against the bias of the spring such that the protuberance is in the extended position thereof in response to fluid pressure.

8. The mold of claim 5 wherein said at least one core pull comprises a spring biasing the piston such that the protuberance is in the extended position thereof, and wherein the piston is moveable against the bias of the spring such that the protuberance is in the retracted position thereof in response to fluid pressure.

9. The mold of claim 5 wherein the piston is moveable from a position such that the protuberance is in the retracted position thereof to a position such that the protuberance is in the extended position thereof by application of positive fluid pressure, and is moveable from the position such that the protuberance is in the extended position thereof to the position such that the protuberance is in the retracted position thereof by application of negative fluid pressure.

10. A mold for creating a double wall blow molded article, the mold having a cavity side and a core side, the core side of said mold comprising:
a mold surface against which the article bears during molding;
at least one core pull disposed within the core side of said mold, said at least one core pull comprising a piston having a protuberance, the piston being moveable, at least partially in response to fluid pressure, between an extended position in which the protuberance protrudes beyond the mold surface, and a retracted position in which the protuberance does not substantially protrude beyond the mold surface, the piston being moveable generally perpendicular to a mold open-close plane of said mold;
at least one ejector pin disposed within the core side of said mold, said at least one ejector pin comprising an end moveable between an extended position in which the end protrudes beyond the mold surface, and a retracted position in which the end does not substantially protrude beyond the mold surface, the end being moveable generally parallel to the mold open-close plane of said mold;
wherein the protuberance of said at least one core pull is in the extended position thereof and the end of said at least one ejector pin is in the retracted position thereof during a part retaining portion of a mold cycle; and
wherein the protuberance of said at least one core pull is in the retracted position thereof and the end of said at least one ejector pin is in the extended position thereof during a part ejecting portion of the mold cycle.

11. The mold of claim 10 wherein the fluid pressure comprises pneumatic pressure.

12. The mold of claim 10 wherein said at least one core pull comprises a spring biasing the piston such that the protuberance is in the retracted position thereof, and wherein the piston is moveable against the bias of the spring such that the protuberance is in the extended position thereof in response to fluid pressure.

13. The mold of claim 10 wherein said at least one core pull comprises a spring biasing the piston such that the protuberance is in the extended position thereof, and wherein the piston is moveable against the bias of the spring such that the protuberance is in the retracted position thereof in response to fluid pressure.

14. The mold of claim 10 wherein the piston is moveable from a position such that the protuberance is in the retracted position thereof to a position such that the protuberance is in the extended position thereof by application of positive fluid pressure, and is moveable from the position such that the protuberance is in the extended position thereof to the position such that the protuberance is in the retracted position thereof by application of negative fluid pressure.

15. A mold for creating a double wall blow molded article, the mold having a cavity side and a core side, the core side of said mold comprising:
a mold surface against which the article bears during molding;
at least one core pull disposed within the core side of said mold, said at least one core pull comprising a piston having a protuberance, the piston being moveable, at least partially in response to fluid pressure, between an extended position in which the protuberance protrudes beyond the mold surface, and a retracted position in which the protuberance does not substantially protrude beyond the mold surface, the piston being moveable generally perpendicular to a mold open-close plane of said mold;
wherein the protuberance of said at least one core pull is in the extended position thereof during a part retaining portion of a mold cycle; and
wherein the protuberance of said at least one core pull is in the retracted position thereof during a part ejecting portion of the mold cycle.

16. The mold of claim 15 wherein the fluid pressure comprises pneumatic pressure.

17. The mold of claim 15 wherein said at least one core pull comprises a spring biasing the piston such that the protuberance is in the retracted position thereof, and wherein the piston is moveable against the bias of the spring such that the protuberance is in the extended position thereof in response to fluid pressure.

18. The mold of claim 15 wherein said at least one core pull comprises a spring biasing the piston such that the protuberance is in the extended position thereof, and wherein the piston is moveable against the bias of the spring such that the protuberance is in the retracted position thereof in response to fluid pressure.

19. The mold of claim 15 wherein the piston is moveable from a position such that the protuberance is in the retracted position thereof to a position such that the protuberance is in the extended position thereof by application of positive fluid pressure, and is moveable from the position such that the protuberance is in the extended position thereof to the position such that the protuberance is in the retracted position thereof by application of negative fluid pressure.

20. A method of creating an article comprising the steps of:
providing a mold having a cavity side and a core side, the core side having a mold surface against which the article bears during molding;
causing a protuberance of at least one core pull to protrude beyond the mold surface;
causing an end of at least one ejector pin to be retracted such that it does not substantially protrude beyond the mold surface;
molding the article within the mold;
opening the mold;
retracting the protuberance of the at least one core pull such that it does not substantially protrude beyond the mold surface; and
ejecting the article from the core side of the mold by causing the end of the at least one ejector pin to protrude beyond the mold surface.

21. The method of claim 20 wherein the at least one core pull is disposed such that the protuberance thereof is moveable generally perpendicular to a mold open-close plane of the mold.

22. The method of claim 21 wherein the at least one ejector pin is disposed such that the end thereof is moveable generally parallel to the mold open-close plane of the mold.

23. The method of claim 20 wherein the at least one core pull comprises a piston, and wherein the protuberance comprises a portion of the piston.

24. The method of claim 23 wherein the piston is moveable at least in part in response to fluid pressure.

25. The method of claim 24 wherein the fluid pressure comprises pneumatic pressure.

26. The method of claim 24 wherein the at least one core pull comprises a spring biasing the piston such that the protuberance does not substantially protrude beyond the mold surface, and wherein the piston is moveable against the bias of the spring, in response to fluid pressure, such that the protuberance protrudes beyond the mold surface.

27. The method of claim 24 wherein the at least one core pull comprises a spring biasing the piston such that the protuberance protrudes beyond the mold surface, and wherein the piston is moveable against the bias of the spring, in response to fluid pressure, such that the protuberance does not substantially protrude beyond the mold surface.

28. The method of claim 24 wherein the piston is moveable from a position such that the protuberance does not substantially protrude beyond the mold surface to a position such that the protuberance protrudes beyond the mold surface by application of positive fluid pressure, and is moveable from the position such that the protuberance protrudes beyond the mold surface to the position such that the protuberance does not substantially protrude beyond the mold surface by application of negative fluid pressure.
